(19) United States
(12) Patent Application Publication
(10) Pub. No.: US 2007/0241682 A1
(43) Pub. Date: Oct. 18, 2007

(54) Display apparatus

(76) Inventors: Hyoung-Bin Park, Suwon-si (KR); Seung-Hyun Son, Suwon-si (KR); Sang-Hun Jang, Suwon-si (KR); Gi-Young Kim, Suwon-si (KR); Sung-Soo Kim, Suwon-si (KR); Young-Mo Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/783,713

(22) Filed: Apr. 11, 2007

(30) Foreign Application Priority Data
Apr. 12, 2006 (KR) 10-2006-0033195

(51) Int. Cl. H01J 17/49

(52) U.S. Cl. 313/582; 313/584; 313/495

(57) ABSTRACT

A display apparatus includes a first substrate and a second substrate facing each other, barrier ribs between the first and second substrates, the first and second substrates and the barrier ribs partitioning a discharge space into discharge cells, a plurality of discharge electrodes between the first and second substrates, a plurality of electron emission devices in the discharge cells, the electron emission devices adapted to emit electron beams according to a voltage applied thereto, and a first luminescent layer and a second luminescent layer on inner walls of the discharge cells, the first and second luminescent layers emitting light using different luminescence mechanisms.

### BACKGROUND OF THE INVENTION

1. Field of the Invention

The present invention relates to a display apparatus. More particularly, the present invention relates to a display apparatus including at least two luminescent layers having different luminescence mechanisms.

2. Description of the Related Art

In general, display apparatuses may be classified into light emitting type display apparatuses and light receiving type display apparatuses. Light emitting display apparatuses include flat cathode ray tubes (CRTs), plasma display panels (PDPs), electroluminescent displays (ELDs), vacuum fluorescent displays (VFDs), and light emitting diodes (LEDs). Light receiving display apparatuses include liquid crystal displays (LCDs).

Among the light emitting display apparatuses, PDPs display desired text or graphics using a discharge gas injected into a sealed space between a plurality of substrates, applying a discharge voltage to a plurality of discharge electrodes to generate a gas discharge, and exciting phosphor layers with ultraviolet (UV) light generated from the gas discharge to emit visible light. Thus, a conventional PDP generates visible light by continuously supplying and accelerating electrons through a discharge, and exciting red, green, and blue phosphor layers with UV light produced due to collisions between the accelerated electrons and neutral particles.

However, ions that cannot be used to emit light are produced in this process. These unneeded ions are also accelerated, resulting in unnecessary energy loss and reducing discharge efficiency. Also, when discharge cells are reduced in size, the discharge efficiency may be further lowered and unstable discharge may occur. Currently, PDPs are mainly used for video graphics arrays (VGAs) (640×480) or super video graphics arrays (SVGAs) (800×600). However, PDPs having a resolution sufficient for use in high definition televisions (HDTVs) (1920×1035) are needed.

### SUMMARY OF THE INVENTION

The present invention is therefore directed to a display apparatus, which substantially overcomes one or more of the problems due to the limitations and disadvantages of the related art.

It is therefore a feature of an embodiment of the present invention to provide a display apparatus having improved luminous efficiency.

It is therefore another feature of an embodiment of the present invention to provide a display apparatus having a lower discharge voltage.

It is therefore yet another feature of an embodiment of the present invention to provide a display apparatus having an additional a luminescent layer that converts the kinetic energy of electrons into visible light.

At least one of the above and other features and advantages of the present invention may be realized by providing a display apparatus including a display apparatus, including a first substrate and a second substrate facing each other, barrier ribs between the first and second substrates, the first and second substrates and the barrier ribs partitioning a discharge space into discharge cells, a plurality of discharge electrodes between the first and second substrates, a plurality of electron emission devices in the discharge cells, the electron emission devices adapted to emit electron beams according to a voltage applied thereto, and a first luminescent layer and a second luminescent layer on inner walls of the discharge cells, the first and second luminescent layers emitting light using different luminescence mechanisms.

Each of the electron emission devices may include a base electrode acting as a source for emitting electrons, and an electron acceleration layer on the base electrode. The base electrode may be biased to a ground potential. The electron acceleration layer is at least one of an oxidized porous polysilicon (OPPS) layer and an oxidized porous amorphous silicon (OPAS) layer. Each of the electron emission devices may include a grid electrode on the electron acceleration layer, the grid electrode adapted to form an electric field between the base electrode and the grid electrode.

Each of the electron emission devices may include an electron acceleration layer on top surfaces of the discharge electrodes. Each of the electron emission devices comprises a grid electrode formed on the electron acceleration layer, the grid electrode adapted to form an electric field between the discharge electrodes and the grid electrode.

The first luminescent layer may be a primary display layer and the second luminescent layer may convert kinetic energy of electrons into visible light. The second luminescent layer may be formed on portions in the discharge space where electrons emitted from the electron emission devices are most likely to collide. The second luminescent layer may be on portions of the first substrate parallel to the second substrate on which the electron emission devices are formed to correspond to the electron emission devices, and the first luminescent layer may be formed on portions of the upper substrate in the discharge space other than the second luminescent layer. The first luminescent layer may be a phosphor layer and the second luminescent layer may be a cathode luminescent layer or a quantum dot layer.

The discharge electrodes may include pairs of sustain discharge electrodes disposed on one of the substrates, extending in a first direction and adapted to generate a sustain discharge, and address electrodes disposed on another one of the substrates and extending in a second direction to cross the pairs of sustain discharge electrodes and adapted to generate an address discharge.

The display apparatus may include a dielectric layer covering the pairs of sustain discharge electrodes. The electron emission devices may be on a surface of the dielectric layer, and may include a base electrode acting as a source for emitting electrons and an electron acceleration layer formed on the base electrode.

At least one of the above and other features and advantages of the present invention may be realized by providing a display apparatus, including a plurality of sub-pixels, a plurality of signal transmitters associated with each sub-pixel, a plurality of electron emission devices in the sub-pixels, the electron emission devices adapted to emit electron beams according to a voltage applied thereto, and a primary luminescent layer and a secondary luminescent layer within the sub-pixels, the primary luminescent layer adapted to generate visible light in response to outputs of the signal transmitters and the secondary luminescent layer adapted to generate light in response to electron beams.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a cross-sectional view of a display apparatus according to an embodiment of the present invention;

FIG. 2 illustrates a cross-sectional view of a display apparatus according to another embodiment of the present invention;

FIG. 3 illustrates a cross-sectional view of a display apparatus according to another embodiment of the present invention;

FIG. 4 illustrates a cross-sectional view of a display apparatus according to another embodiment of the present invention;

FIG. 5 illustrates a cross-sectional view of a display apparatus according to another embodiment of the present invention; and

FIG. 6 illustrates a cross-sectional view of a display apparatus according to another embodiment of the present invention.

### DETAILED DESCRIPTION OF THE INVENTION

Korean Patent Application No. 10-2006-0033195, filed on Apr. 12, 2006, in the Korean Intellectual Property Office, and entitled: “DISPLAY APPARATUS,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The present invention will now be described more fully with reference to the accompanying drawings, in which exemplary embodiments of the invention are shown.

FIG. 1 illustrates a cross-sectional view of an alternating current (AC) display apparatus 200 according to an embodiment of the present invention.

Referring to FIG. 1, the AC display apparatus 200 may include a first substrate 201, and a second substrate 202 spaced apart from and parallel to the first substrate 201. Frit glass may be coated along edges of inner facing surfaces of the first substrate 201 and the second substrate 202 to form a sealed discharge space.

Each of the first substrate 201 and the second substrate 202 may be a transparent substrate made of soda lime glass, a semi-transparent substrate, a reflective substrate, or a colored substrate. When visible light is to be transmitted through the second substrate 202, the second substrate 202 may be made of a material having high transmittance.

A plurality of pairs of sustain discharge electrodes 203 may be formed on the inner surface of the first substrate 201, and may extend in a first direction. Each pair of sustain discharge electrodes 203 may include an X electrode 204 and a Y electrode 205 disposed in a discharge cell. The X electrode 204 and the Y electrode 205 may face each other in each discharge cell, and may be symmetrical with each other to achieve uniform discharge. Although the X electrodes 204 and the Y electrodes 205 may be made of a material having high conductivity, e.g., silver (Ag) paste, the present embodiment need not be limited thereto.

The X electrodes 204 and the Y electrodes 205 may be covered by a first dielectric layer 206. The first dielectric layer 206 may be formed of a white, high dielectric material, e.g., PbO—B₂O₃—SiO₂, to reflect visible light generated in the discharge space. A protective layer 207, e.g., magnesium oxide (MgO), may be formed on a surface of the first dielectric layer 206 to increase the number of secondary electrons emitted from the X electrodes 204 and the Y electrodes 205.

Address electrodes 208 may be disposed on an inner surface of the second substrate 202, and may extend in a second direction to cross the X electrodes 204 and the Y electrodes 205. The address electrodes 208 may cross adjacent discharge cells. The address electrodes 208 may be formed of a transparent conductive material, e.g., Indium Tin Oxide (ITO), through which visible light may be transmitted. A metal material having high conductivity may be further added to the address electrodes 208 to improve the electrical conductivity of the address electrodes 208.

The address electrodes 208 may be covered by a second dielectric layer 209. The second dielectric layer 209 may be made of a transparent, high dielectric material, similar to the first dielectric layer 206.

A plurality of barrier ribs 210 may be disposed between the first substrate 201 and the second substrate 202. The barrier ribs 210 may partition the discharge space into discharge cells, and may prevent crosstalk between adjacent discharge cells. The barrier ribs 210 are not limited in shape, and may be, e.g., striped, meander-shaped, matrix-shaped, or any shape as long as they partition the discharge space. Accordingly, the discharge cells may have various cross-sections, e.g., polygonal, circular, and oval.

A discharge gas may be injected into the sealed inner space formed by securing the first substrate 201, the second substrate 202, and the barrier ribs 210. The discharge gas may be, e.g., neon (Ne), helium (He), argon (Ar) that contains xenon (Xe), or a gas mixture of at least two of these gases. The gas in the discharge cells may be any gas that may be excited by external energy due to electron beams emitted from an electron source and that can produce UV light. That is, instead of the gas containing Xe, the discharge gas may contain N₂, deuterium gas, carbon dioxide, hydrogen gas, carbon monoxide, krypton, or atmospheric air.

Luminescent layers 211 may be on inner walls of the discharge cells. The luminescent layers 211 may include a first luminescent layer 212 and a second luminescent layer 213, which may emit light using different luminescence mechanisms. For example, the first luminescent layer 212 may be a photoluminescent (PL) layer based on a photoluminescence mechanism by which visible light may be emitted when UV light is absorbed. The second luminescent layer 213 may convert kinetic energy of electrons in the discharge space into visible light to prevent energy loss due to conversion of electron energy into heat, and also may prevent a rise in temperature when the electrons generated due to ionization during the discharge collide in the discharge space with residual energy used for the gas excitation, etc.

The first luminescent layer 212 may be made of a material having high luminous efficiency at a wavelength to be generated by the discharge gas, e.g., 147-nm vacuum UV (VUV) light when the discharge gas includes Xe. As described above, the discharge gas used in the AC display apparatus 200 may be He, Ne, Ar, or the like, a buffer gas may be formed using a gas mixture of these gases, and a small amount of Xe may be mixed with the buffer gas. Plasma produced in this process generates high-pressure glow discharge near atmospheric pressure to emit VUV light, which may serve as an excitation source for the first luminescent layer 212.

The first luminescent layer 212 of each discharge cell may include a red, green, or blue phosphor layer according to the sub-pixel required to realize a color image. Each discharge cell may serve as a sub-pixel. The red phosphor layer may include (Y,Gd)BO₃:Eu⁺³, the green phosphor layer may include Zn₂SiO₄:Mn²⁺, and the blue phosphor layer may include BaMgAl₁₀O₁₇:Eu²⁺. The present embodiment need not be limited thereto, e.g., the blue phosphor layer may include CaMgSi₂O₈: Eu²⁺, or a mixture of BaMgAl₁₀O₁₇:Eu²⁺ and CaMgSi₂O₈: Eu²⁺.

The second luminescent layer 213 may be a cathode luminescent (CL) layer or a quantum dot (QD) layer. The CL layer may be formed of a sulfide fluorescent material. Since there is no interference between atoms in the QD layer, when the QD layer receives external energy, electrons excited at the atomic energy level are stabilized, and the QD layer may then emit light, e.g., light over a broad spectrum of visible wavelengths or white light. As a result, since the electrons may be excited at a low voltage, luminous efficiency can be improved. Also, since the QD layer may be fabricated using a printing process, the size of the AC display apparatus 200 may be increased.

Electron emission devices 214 may be on a top surface of the first dielectric layer 206. The electron emission devices 214 may efficiently emit electrons into the discharge space by a magnetic field formed when a sustain discharge voltage is applied to the X electrodes 204 and the Y electrodes 205. Each of the electron emission devices 214 may include a base electrode 215 formed on the top surface of the first dielectric layer 206, and an electron acceleration layer 216, which may have a same width as the base electrode 215, and may be formed on a top surface of the base electrode 215.

The base electrode 215 may be made of a transparent conductive material, e.g., ITO, or a metal material having high conductivity, e.g., Al or Ag. The base electrode 215 may be coupled to ground and biased to 0 V. The electron acceleration layer 216 may be any material that can accelerate electrons and generate electron beams, and may be an oxidized porous silicon (OPS) layer. Here, OPS may be oxidized porous polysilicon (OPPS) or oxidized porous amorphous silicon (OPAS).

Alternatively, the electron emission devices 214 may include boron nitride bamboo shoot (BNBS). Since BNBS is transparent in a wavelength range of approximately 380 to 780 μm, which is in the visible range, and has negative (−) electron affinity, BNBS is known to have a high electron emission characteristic. When the electron emission devices 214 include BNBS, a BNBS layer may be formed on the top surface of the base electrode 215, and the base electrode 215 and the BNBS layer may have the same width.

The electron emission devices 214 may correspond to the X electrodes 204 and the Y electrodes 205. The first luminescent layer 212 may be on a bottom surface of the second dielectric layer 209, and may correspond to a discharge gap between adjacent X and Y electrodes 204 and 205. The first luminescent layer 212 may be on outer sidewalls of the barrier ribs 210.

The second luminescent layer 213 may be on a portion of the bottom surface of the second dielectric layer 209 where the first luminescent layer 212 is not present and where electrons emitted from the electron emission devices 214 collide most often in the discharge space.

The operation of the AC display apparatus 200 constructed as above will now be explained.

First, an external image signal is converted into a signal for outputting a desired image by an image processing unit and a logic control unit, and then is applied to the X electrodes 204, the Y electrodes 205, and the address electrodes 208.

After an initialization (or reset) period and a wall charge accumulation period, a driving voltage is applied to a discharge cell, which is selected to output an image at a certain time, through the X electrode 204 and the Y electrode 205 as many times as proportional to the desired brightness. Then, wall charges accumulated in a sustaining period are added to wall charges accumulated on the first dielectric layer 206 in an addressing period and the voltage difference between the X and Y electrodes 204 and 205 is greater than a discharge firing voltage, thereby firing a discharge between the X and Y electrodes 204 and 205.

Once the discharge occurs, discharge gas particles and charges in the selected discharge cell collide with each other to generate plasma. When excited discharge gas atoms are stabilized by the plasma environment, VUV light is emitted. When the VUV light is absorbed by the first luminescent layer 212, electrons therein excited. When the excited electrons are stabilized, visible light is emitted. When the emitted visible light passes through the second substrate 202 and is combined with visible light emitted from other discharge cells, an image is created.

Meantime, when the base electrode 215 is biased to 0 V and discharge is started between the X electrode 204 and the Y electrode 205, the discharge space has a low electrical resistance, such that electric fields contacting the electron acceleration layers 216, and the X and Y electrodes 204 and 205 have almost the same potential. Accordingly, a voltage high enough to accelerate the electrons may be generated between the electron acceleration layers 216.

When a voltage is applied between the electron acceleration layers 216, the base electrodes 215 become cathode electrodes, and electrons introduced from the cathode electrodes 215 are injected into the electron acceleration layers 216. When a region between the electron acceleration layers 216 formed of nanocrystalline silicon is covered by a thin oxide layer, most of the applied voltage may be concentrated on the thin oxide layer between the electron acceleration layers 216 to form a strong electric field.

In the AC display apparatus 200, pulse voltages equal in magnitude, but opposite in polarity, may be alternately applied to the X electrode 204 and the Y electrode 205. Accordingly, a voltage high enough to accelerate the electrons may be continuously generated between the electron acceleration layers 216.

When the oxide layer between the electron acceleration layers 216 is very thin, the electrons may easily pass through the oxide layer due to the tunneling effect. Also, the electrons may be accelerated whenever they pass through the strong electric field formed by the pulse voltages. Since this electron acceleration may occur repeatedly toward the surface of electrodes, the electrons may pass through the surface of electrodes due to the tunneling effect as well, thereby emitting electron beams into the discharge cell.

The emitted electron beams excite the gas, and the excited gas generates VUV light. The VUV light excites the second luminescent layer 213 to generate visible light, and the generated visible light may be emitted through the second substrate 202 to form an image.

In this regard, in addition to the VUV light generated when the discharge gas atoms ionized by the plasma environment are stabilized, VUV light may be generated when electron beams accelerated by the electron acceleration layers 216 excite the discharge gas and the excited discharge gas atoms are stabilized. Also, the accelerated electrons may be efficiently supplied into the discharge space through the electron acceleration layers 216. As a result, the AC display apparatus 200 may achieve high brightness and high efficiency in the discharge cell.

When the second luminescent layer 213 is formed on the portion of the bottom surface of the second dielectric layer 209 where the electrons emitted from the electron acceleration layers 216 collide most often, the second luminescent layer 213 may emit light by utilizing the kinetic energy of the electrons, which are generated by the ionization in the discharge space during the discharge, when they collide with the surface of the second dielectric layer 209 with residual energy used for the gas excitation and the like, thereby improving luminous efficiency.

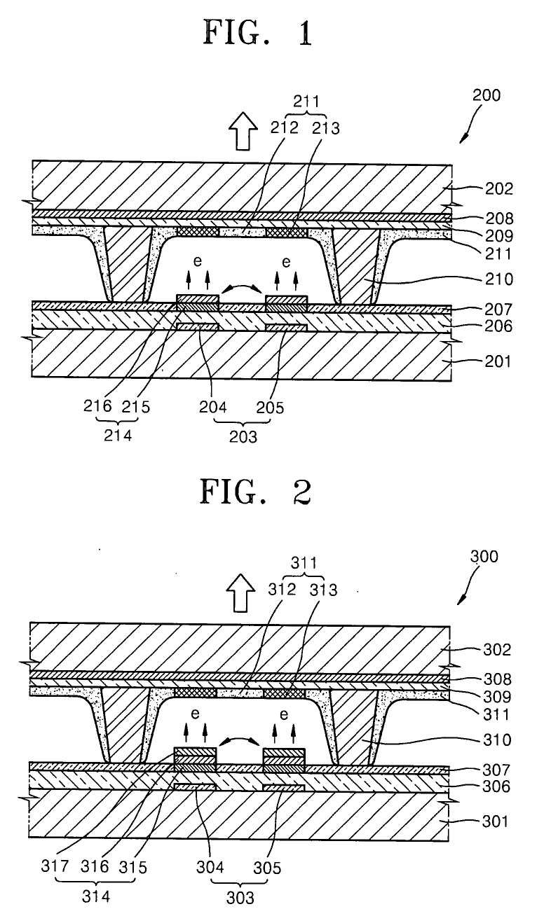

Additional exemplary embodiments of the present invention will now be described with reference to FIGS. 2-6. It is to be understood that the variations on the general structure of the display, examples of materials to be used for particular elements, and the operation of the display discussed above are similarly applicable to these additional embodiments, and may not be repeated.

FIG. 2 illustrates a cross-sectional view of an AC display apparatus 300 according to another embodiment of the present invention.

Referring to FIG. 2, the AC display apparatus 300 may include a first substrate 301, and a second substrate 302 spaced apart from and parallel to the first substrate 301.

A plurality of pairs of sustain discharge electrodes 303 each may include an X electrode 304 and a Y electrode 305 on an inner surface of the first substrate 301 and may extend in a first direction. The pairs of sustain discharge electrodes 303 may be covered by a first dielectric layer 306. A protective layer 307 may be formed on a surface of the first dielectric layer 306.

Address electrodes 308 may be disposed on an inner surface of the second substrate 302, and may extend in a second direction to cross the pairs of sustain discharge electrodes 303. The address electrodes 308 may be covered by a second dielectric layer 309.

A plurality of barrier ribs 310 may be disposed between the first substrate 301 and the second substrate 302. A discharge gas may be injected into a sealed inner space or discharge apace formed by a combination of the first substrate 301, the second substrate 302, and the barrier ribs 310. The barrier ribs 310 may partition the discharge space into a plurality of discharge cells.

Electron emission devices 314 may be on a top surface of the first dielectric layer 306. Each of the electron emission devices 314 may include a base electrode 315 on the top surface of the first dielectric layer 306, an electron acceleration layer 316, which may have the same width as the base electrode 315, on a top surface of the base electrode 315, and a grid electrode 317 on a top surface of the electron acceleration layer 316.

The base electrode 315 and the grid electrode 317 may be made of transparent conductive materials, or materials having high conductivity. The electron acceleration layer 316 may be an OPS layer that may accelerate electrons and generate electron beams. The OPS layer may be an OPPS layer or an OPAS layer. Alternatively, the electron emission devices 314 may include a BNBS layer.

Luminescent layers 311 may include first and second luminescent layers 312 and 313, which emit light using different luminescence mechanisms, and may be in an inner space of the discharge cells.

The first luminescent layer 312 may be a PL layer that emits visible light when UV light generated due to gas excitation during a discharge is absorbed and excited electrons are stabilized. The second luminescent layer 313 may be a CL layer or a QD layer that may convert the kinetic energy of electrons in the discharge space into visible light when the electrons generated due to ionization in the discharge space during the discharge collide in the discharge space with energy used for the gas excitation and the like.

The electron emission devices 314 may be on the top surface of the first dielectric layer 306, and may correspond to the X electrode 304 and the Y electrode 305. The first luminescent layer 312 may be on a bottom surface of the second dielectric layer 309, and may correspond to a gap between the X electrode 304 and the Y electrode 305. The first luminescent layer 312 may also be on outer sidewalls of the barrier ribs 310. The second luminescent layer 313 may be formed on a portion of the bottom surface of the second dielectric layer 309 where the electrons emitted from the electron emission devices 314 collide most often in the discharge space, e.g., on the bottom surface of the second dielectric layer 309 to correspond to the electron emission devices 314.

The base electrode 315 may be biased to a ground potential, and the base electrode 315 and the grid electrode 317 to which a direct current (DC) voltage is to be applied may control the energy of the electron beams emitted from the electron acceleration layers 316 according to the magnitude of the DC voltage applied thereto. Accordingly, the accelerated electrons may be efficiently supplied to the discharge space through the electron acceleration layers 316, thereby achieving high brightness and high luminous efficiency.

Since the electrons output with the voltage applied between the base electrode 315 and the grid electrode 317 may be controlled to have an energy greater than that required for exciting the gas and less than that necessary to ionize the gas, the luminescent layers 311 may allow only gas excitation without discharge.

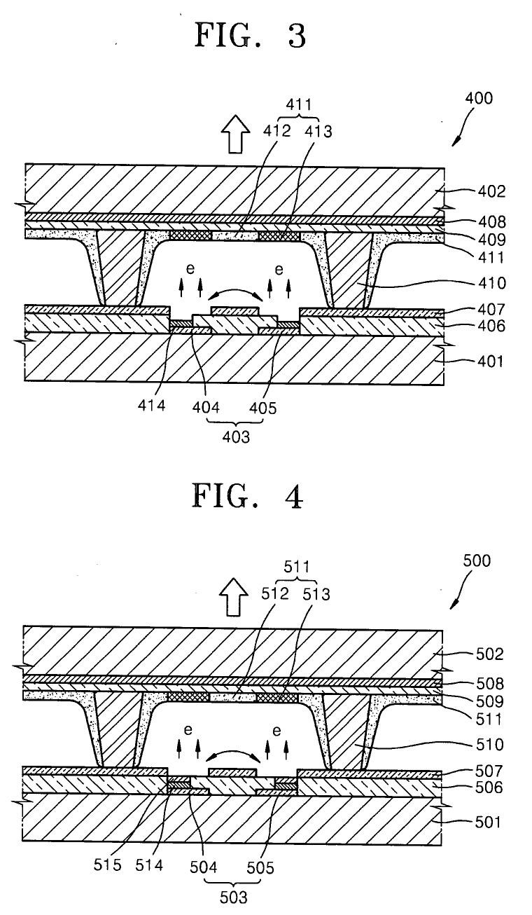

FIG. 3 illustrates a cross-sectional view of an AC display apparatus 400 according to another embodiment of the present invention.

Referring to FIG. 3, the display apparatus 400 may include a first substrate 401, and a second substrate 402 spaced apart from and parallel to the first substrate 401.

A plurality of barrier ribs 410 may be disposed between the first substrate 401 and the second substrate 402. A discharge gas may be injected into a sealed inner space or discharge apace formed by a combination of the first substrate 401, the second substrate 402, and the barrier ribs 410. The barrier ribs 410 may partition the discharge space into a plurality of discharge cells.

A plurality of pairs of sustain discharge electrodes 403 may be on a top surface of the first substrate 401, and may extend in a first direction. Each of the pairs of sustain discharge electrodes 403 may include an X electrode 404 and a Y electrode 405 in each discharge cell. The X electrodes 404 and the Y electrodes 405 may be alternately disposed on the top surface of the first substrate 401. The X electrode 404 and the Y electrode 405 may be at least partially covered by a first dielectric layer 406. A protective layer 407 may be formed on a surface of the first dielectric layer 406.

Address electrodes 408 may be on an inner surface of the second substrate 402, and may extend in a second direction to cross the pairs of sustain discharge electrodes 403. The address electrodes 408 may be covered by a second dielectric layer 409.

As can be seen in FIG. 3, the first dielectric layer 406 may be over the top surface of the first substrate 401 except edges of top surfaces of the X electrode 404 and the Y electrode 405, such that the edges of the top surfaces of the X electrode 404 and the Y electrode 405 are exposed. The first dielectric layer 406 may be formed of a material having high insulation resistance. However, the present embodiment need not be limited thereto, and the X electrode 404 and the Y electrode 405 may not be covered by the first dielectric layer 406, such that the entire top surfaces of the X electrode 404 and the Y electrode 405 may be exposed.

Electron acceleration layers 414 of electron emission devices may be formed on the exposed edges of the top surfaces of the X electrodes 404 and the Y electrodes 405 not covered by the first dielectric layer 406. The electron acceleration layers 414 may be made of an OPS layer that may accelerate electrons and generate electron beams. The OPS layer may be an OPPS layer or an OPAS layer. Alternatively, the electron emission devices may include a BNBS layer.

Accordingly, in the present embodiment, unlike the previous embodiments in which the base electrodes are additionally provided, the X electrodes 404 and the Y electrodes 405 may be used as base electrodes of the electron emission devices.

Luminescent layers 411 may be on inner walls of the discharge cells. The luminescent layers 411 may include a first luminescent layer 412 and a second luminescent layer 413, which emit light using different luminescence mechanisms.

The first luminescent layer 412 may be on the bottom surface of the second dielectric layer 409, may correspond to a discharge gap between the X electrode 404 and the Y electrode 405, and may be on outer sidewalls of the barrier ribs 410. The first luminescent layer 412 may be a PL layer that may emit visible light when UV light generated due to gas excitation during a discharge is absorbed and excited electrons are stabilized.

The second luminescent layer 413 may formed on a portion of the bottom surface of the second dielectric layer 409 where the first luminescent layer 412 is not formed and where the electrons accelerated by the electron acceleration layers 414 collide most often in the discharge space, and may correspond to the X electrodes 204 and the Y electrodes 205. The second luminescent layer 413 may be a CL layer or a QD layer that can convert the kinetic energy of electrons into visible light when the electrons generated due to ionization in the discharge space during the discharge collide in the discharge space with energy used in the gas excitation, etc.

FIG. 4 illustrates a cross-sectional view of an AC display apparatus 500 according to another embodiment of the present invention.

Referring to FIG. 4, the AC display apparatus 500 may include a first substrate 501, and a second substrate 502 spaced apart from and parallel to the first substrate 501.

A plurality of barrier ribs 510 may be disposed between the first substrate 501 and the second substrate 502. A discharge gas may be injected into a sealed inner space or discharge apace formed by a combination of the first substrate 501, the second substrate 502, and the barrier ribs 510. The barrier ribs 510 may partition the discharge space into a plurality of discharge cells.

A plurality of pairs of sustain discharge electrodes 503 may be on a top surface of the first substrate 501, and may extend in a first direction. Each of the pairs of sustain discharge electrodes 503 may include an X electrode 504 and a Y electrode 505 in each discharge cell. The X electrodes 504 and the Y electrodes 505 may be alternately disposed on the top surface of the first substrate 501. The X electrode 504 and the Y electrode 505 may be at least partially covered by a first dielectric layer 506. A protective layer 507 may be formed on a surface of the first dielectric layer 506.

Address electrodes 508 may be on an inner surface of the second substrate 502, and may extend in a second direction to cross the pairs of sustain discharge electrodes 503. The address electrodes 508 may be covered by a second dielectric layer 509.

As can be seen in FIG. 4, the first dielectric layer 506 may be over the surface of the first substrate 501 except edges of top surfaces of the X electrode 504 and the Y electrode 505. Alternatively, the fist dielectric layer 506 may be omitted and the entire top surfaces of the X electrode 504 and the Y electrode 505 may be exposed.

Electron acceleration layers 514 may be formed on the exposed edges of the top surfaces of the X electrode 504 and the Y electrode 505. The electron acceleration layers 514 may include an OPS layer or a BNBS layer. The X electrode 504 and the Y electrode 505 may be used as base electrodes for supplying electrons to the electron acceleration layers 514. Grid electrodes 515 may be on top surfaces of the electron acceleration layers 514.

Luminescent layers 511 may be formed on inner walls of the discharge cells, and may include a first luminescent layer 512 and a second luminescent layer 513, which emit light based on different luminescence mechanisms.

The first luminescent layer 512 may be a PL layer that emits visible light when UV light generated due to gas excitation during a discharge is absorbed. The first luminescent layer 512 may be on a bottom surface of the second dielectric layer 509, and may correspond to a discharge gap between the X electrode 504 and the Y electrode 505. The first luminescent layer 512 may also be on outer sidewalls of the barrier ribs 510.

The second luminescent layer 513 may be a CL layer or a QD layer that may convert the kinetic energy of electrons into visible light when the electrons generated due to ionization during the discharge collide with inner walls of the discharge cells with energy used for the gas excitation. The second luminescent layer 513 may be on the bottom surface of the second dielectric layer 509, and may correspond to the sequential stacks of the electron acceleration layers 514 and the grid electrodes 515. The second luminescent layer 513 may be on portions of the bottom surface of the second dielectric layer 509 where the electrons accelerated by the electron acceleration layers 514 collide in the discharge, space most often.

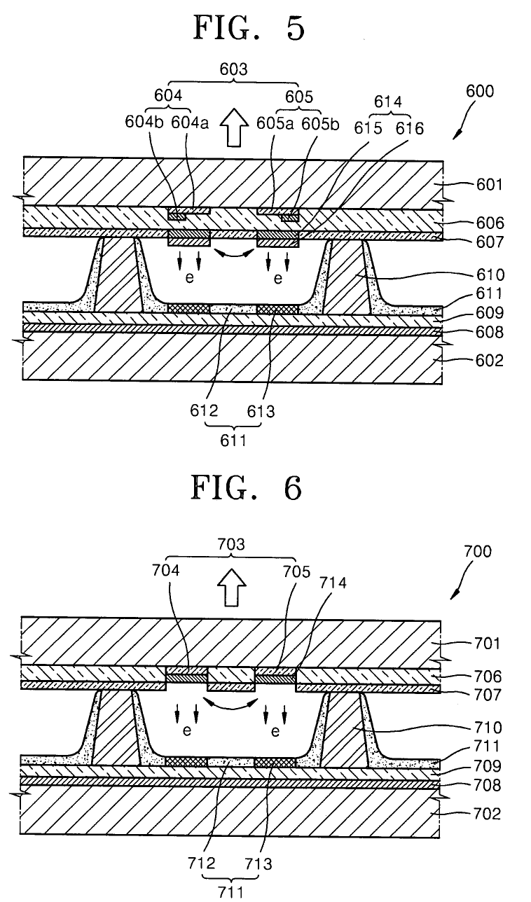

FIG. 5 is a cross-sectional view of an AC display apparatus 600 according to another embodiment of the present invention.

Referring to FIG. 5, the AC display apparatus 600 may include a first substrate 601, and a second substrate 602 spaced apart from and parallel to the first substrate 601. The first substrate 601 may be made of a material through which visible light can be transmitted.

A plurality of barrier ribs 610 may be disposed between the first substrate 601 and the second substrate 602. A discharge gas may be injected into a sealed inner space or discharge apace formed by a combination of the first substrate 601, the second substrate 602, and the barrier ribs 610. The barrier ribs 610 may partition the discharge space into a plurality of discharge cells.

A plurality of pairs of sustain discharge electrodes 603 may be on an inner surface of the first substrate 601, and may extend in a first direction. Each of the pairs of sustain discharge electrodes 603 may include an X electrode 604 and a Y electrode 605 in each discharge cell. The X electrodes 604 and the Y electrodes 605 may be alternately disposed on the inner surface of the first substrate 601.

The X electrode 604 may include a first transparent electrode line 604a, and a first bus electrode line 604b disposed on an edge of a top surface of the first transparent electrode line 604a, and the Y electrode 605 may include a second transparent electrode line 605a and a second bus electrode line 605b disposed on an edge of a top surface of the second transparent electrode line 605a.

Each of the first transparent electrode line 604a and the second transparent electrode line 605a may be made of a transparent conductive material, e.g., ITO, through which visible light can be transmitted. Each of the first bus electrode line 604b and the second bus electrode line 605b may made of a material having high conductivity, e.g., Ag paste or chrome-copper-chrome, to improve the electrical conductivity thereof.

However, the present embodiment need not limited thereto, and each of the X electrode 604 and the Y electrode 605 may be formed of an ITO-less structure without a transparent conductive material. The X electrodes 604 and the Y electrodes 605 may be covered by a first dielectric layer 606, and a protective layer 607 may be on a top surface of the first dielectric layer 606.

Electron acceleration devices 614 may be formed on the top surface of the first dielectric layer 606, and may correspond to the X electrode 604 and the Y electrode 605. That is, each of the electron acceleration devices 614 may include a base electrode 615 formed on the top surface of the first dielectric layer 606, and an electron acceleration layer 616, which may have the same width as the base electrode 615, formed on a top surface of the base electrode 615.

The base electrode 615 may be formed of a transparent conductive material such as ITO, or a material having high conductivity, such as Ag or Al. The base electrode 615 is coupled to ground and biased to 0 V.

The electron acceleration layer 616 may be made of any material that can generate electron beams by accelerating electrons, and may be an OPS layer. The OPS layer may be an OPPS, or an OPAS layer. Alternatively, the electron acceleration layer 616 may be a BNBS layer.

Address electrodes 608 may be on a top surface of the second substrate 602, and may extend in a second direction to cross the pairs of sustain discharge electrodes 603. The address electrodes 608 may be covered by a second dielectric layer 609.

Luminescent layers 611 may be formed on inner walls of the discharge cells. The luminescent layers 611 may include a first luminescent layer 612 and a second luminescent layer 613, which emit light using different luminescence mechanisms.

The first luminescent layer 612 may be made of a material that emits visible light using UV light generated due to gas excitation, e.g., a PL layer. The second luminescent layer 613 may be made of a material that can emit light using the kinetic energy of electrons, e.g., a CL layer or a QD layer.

The first luminescent layer 612 may be on a top surface of the second dielectric layer 609, and may correspond to a discharge gap between the X and Y electrodes 604 and 605. The first luminescent layer 612 may also be on outer sidewalls of the barrier ribs 610. The second luminescent layer 613 may be on the top surface of the second dielectric layer 609, and may correspond to the electron emission devices 614. The second luminescent layer 613 may be on portions of the top surface of the second dielectric layer 609 where the electrons emitted from the electron emission devices 614 collide in the discharge space most often.

Accordingly, since the first luminescent layer 612 emits light using UV light generated by gas excitation and the second luminescent layer 613 emits light using the kinetic energy of the electrons emitted from the electron emission devices 614 during a discharge, the display apparatus 600 can improve luminous efficiency.

FIG. 6 is a cross-sectional view of an AC display apparatus 700 according to another embodiment of the present invention.

Referring to FIG. 6, the AC display apparatus 700 may include a first substrate 701, and a second substrate 702 spaced apart from and parallel to the first substrate 701. The first substrate 701 may be made of a material through which visible light can be transmitted.

A plurality of barrier ribs 710 may be disposed between the first substrate 701 and the second substrate 702. A discharge gas may be injected into a sealed inner space or discharge apace formed by a combination of the first substrate 701, the second substrate 702, and the barrier ribs 710. The barrier ribs 710 may partition the discharge space into a plurality of discharge cells.

A plurality of pairs of sustain discharge electrodes 703 may be on an inner surface of the first substrate 701, and may extend in a first direction. Each of the pairs of sustain discharge electrodes 703 may include an X electrode 704 and a Y electrode 705 in each discharge cell. The X electrodes 704 and the Y electrodes 705 may be alternately disposed on the inner surface of the first substrate 701.

Electron acceleration layers 714 of electron emission devices may be formed on top surfaces of the X electrode 704 and the Y electrode 705. The electron acceleration layers 714 may be made of a material that can accelerate electrons and generate electron beams, such as an OPS layer. The OPS layer may be an OPPS layer or an OPAS layer. Alternatively, the electron emission devices may include a BNBS layer.

Base electrodes may not be additionally provided in the present embodiment. Instead, the X electrode 704 and the Y electrode 705 may serve as base electrodes for the electron emission devices. Grid electrodes (not shown) may be on top surfaces of the electron acceleration layers 714 to control the intensity of electron beams passing through the electron acceleration layers 714.

However, the present embodiment need not limited thereto, and the X electrode 704 and the Y electrode 705 may be both formed of transparent conductive layers, formed of a transparent conductive layer and a material having high electrical conductivity, e.g., Ag, Al, or chrome-copper-chrome, or both formed of materials having high conductivity. The electron acceleration layers 714 may be variously designed according to the structures of the X electrode 704 and the Y electrode 705.

Address electrodes 708 may be disposed on an inner surface of the second substrate 702 and extend in a second direction to cross the X electrodes 704 and the Y electrodes 705. The address electrodes 708 may be covered by a second dielectric layer 709.

Luminescent layers 711 may be formed in the discharge space, and may include a first luminescent layer 712 and a second luminescent layer 713, which emit light using different luminescence mechanisms. The first luminescent layer 712 may be on a top surface of the second dielectric layer 709, and may correspond to a discharge gap between the X electrode 704 and the Y electrode 705. The first luminescent layer 712 also may be on outer sidewalls of the barrier ribs 710.

The second luminescent layer 713 may be on the top surface of the second dielectric layer 709, and may correspond to the X electrode 704 and the Y electrode 705. The second luminescent layer 713 may be formed on portions where the electrons accelerated by the electron acceleration layers 714 collide in the discharge space most often. The second luminescent layer 713 may be a CL layer or a QD layer.

Accordingly, since the first luminescent layer 712 emits visible light using UV light generated due to gas excitation, and the second luminescent layer 713 emits light by converting the kinetic energy of electrons into visible light, the AC display apparatus 700 may have an improved luminous efficiency.

As described above, the display apparatus according to the present invention uses both a luminescent layer which emits visible light using UV light generated due to gas excitation, and a luminescent layer which emits visible light by converting the kinetic energy of electrons in the discharge space into visible light to prevent or reduce energy loss due to conversion of electron energy into heat and to prevent a rise in temperature when the electrons generated by the electron emission devices or by ionization during the discharge collide in the discharge space with residual energy used for the gas excitation, etc. Accordingly, the display apparatus may improve luminous efficiency and reduce heat generation.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display apparatus, comprising:
a first substrate and a second substrate facing each other;
barrier ribs between the first and second substrates, the first and second substrates and the barrier ribs partitioning a discharge space into discharge cells;
a plurality of discharge electrodes between the first and second substrates;
a plurality of electron emission devices in the discharge cells, the electron emission devices adapted to emit electron beams according to a voltage applied thereto; and
a first luminescent layer and a second luminescent layer on inner walls of the discharge cells, the first and second luminescent layers emitting light using different luminescence mechanisms.

2. The display apparatus as claimed in claim 1, wherein each of the electron emission devices comprises:
a base electrode acting as a source for emitting electrons; and
an electron acceleration layer on the base electrode.

3. The display apparatus as claimed in claim 2, wherein the base electrode is biased to a ground potential.

4. The display apparatus as claimed in claim 2, wherein the electron acceleration layer one of an oxidized porous polysilicon (OPPS) layer and an oxidized porous amorphous silicon (OPAS) layer.

5. The display apparatus as claimed in claim 2, wherein each of the electron emission devices further comprises a grid electrode on the electron acceleration layer, the grid electrode adapted to form an electric field between the base electrode and the grid electrode.

6. The display apparatus as claimed in claim 1, wherein each of the electron emission devices comprises an electron acceleration layer on top surfaces of the discharge electrodes.

7. The display apparatus as claimed in claim 6, wherein each of the electron emission devices comprises a grid electrode formed on the electron acceleration layer, the grid electrode adapted to form an electric field between the discharge electrodes and the grid electrode.

8. The display apparatus as claimed in claim 1, wherein the first luminescent layer is a primary display layer and the second luminescent layer converts kinetic energy of electrons into visible light.

9. The display apparatus as claimed in claim 8, wherein the second luminescent layer is formed on portions in the discharge space where electrons emitted from the electron emission devices are most likely to collide.

10. The display apparatus as claimed in claim 8, wherein the second luminescent layer is formed on portions of the first substrate parallel to the second substrate on which the electron emission devices are formed to correspond to the electron emission devices, and the first luminescent layer is formed on portions of the first substrate in the discharge space other than the second luminescent layer.

11. The display apparatus as claimed in claim 1, wherein the discharge electrodes comprise pairs of sustain discharge electrodes disposed on one of the substrates, extending in a first direction and adapted to generate a sustain discharge, and address electrodes disposed on another one of the substrates and extending in a second direction to cross the pairs of sustain discharge electrodes and adapted to generate an address discharge.

12. The display apparatus as claimed in claim 11, further comprising a dielectric layer covering the pairs of sustain discharge electrodes.

13. The display apparatus as claimed in claim 11, wherein the electron emission devices are formed on a surface of the dielectric layer and each comprise:
a base electrode acting as a source for emitting electrons; and
an electron acceleration layer formed on the base electrode.

14. The display apparatus as claimed in claim 13, wherein the electron acceleration layer is one of an oxidized porous polysilicon (OPPS) layer and an oxidized porous amorphous silicon (OPAS) layer.

15. The display apparatus as claimed in claim 13, wherein each of the electron emission devices further comprises a grid electrode formed on the electron acceleration layer adapted to form an electric field between the base electrode and the grid electrode.

16. The display apparatus as claimed in claim 11, wherein the electron emission devices comprise electron acceleration layers on top surfaces of the pairs of sustain discharge electrodes.

17. The display apparatus as claimed in claim 16, wherein each of the electron emission devices comprises a grid electrode formed on the electron acceleration layer, the grid electrode adapted to form an electric field between the discharge electrodes and the grid electrode.

18. The display apparatus as claimed in claim 11, wherein the first luminescent layer is a phosphor layer and the second luminescent layer is a cathode luminescent layer or a quantum dot layer.

19. The display apparatus as claimed in claim 18, wherein the second luminescent layer is formed on portions of the second substrate, which is above and parallel to the first substrate on which the electron emission devices are formed to correspond to the electron emission devices, and the first luminescent layer is formed on portions of the second substrate other than where the second luminescent layer is formed.
